(19) United States
(12) Patent Application Publication
(10) Pub. No.: US 2004/0008192 A1
(43) Pub. Date: Jan. 15, 2004

(54) Parity checking system and method for a display system

(76) Inventor: John Karl Waterman, Mesa, AZ (US)

Correspondence Address: PORTFOLIO IP LLC, P.O. BOX 52050, MINNEAPOLIS, MN, 55402, US

(21) Appl. No.: 10/316,654

(22) Filed: Dec. 10, 2002

Related U.S. Application Data
(60) Provisional application No. 60/394,913, filed on Jul. 10, 2002.

(51) Int. Cl. G09G 5/00

(52) U.S. Cl. 345/204

(57) ABSTRACT

The integrity of signal connections in a display system, such as a projection television system or cellular phone, between a driver circuit and a display circuit having an LCD micro-display is checked using parity calculations. A first parity is calculated by the driver circuit using only the digital signals to be sent to the display circuit, and a second parity is calculated by the display circuit using both the digital signals and analog signals received from the driver circuit. The first and second parity calculations are done using exclusive OR logic gates. The analog signals received by the display circuit are compared to the common driving voltage for the micro-display to provide inputs, in addition to the digital signals received by the display circuit, for the second parity calculation. The first and second parity are compared to determine the existence of a fault condition, and power to the display is shut down if a fault condition exists.

### RELATED APPLICATIONS

This application is a non-provisional application claiming benefit under 35 U.S.C. sec. 119(e) of U.S. Provisional Application Serial No. 60/394,913, filed Jul. 10, 2002 (titled PARITY CHECKING SYSTEM AND METHOD FOR A DISPLAY SYSTEM by John Karl Waterman), which is incorporated by reference herein.

### BACKGROUND OF THE INVENTION

The present invention relates in general to display systems and, more specifically, to a system and method for parity checking of signal transmission and mechanical connector integrity between circuits in a display system for presenting images to a user such as, for example, a projection television system or a cellular phone.

Projection display systems, such as, for example, a projection television system, commonly use a light valve such as a liquid crystal display (LCD) to create images that are enlarged and projected onto a screen for viewing. Recently, reflective micro-displays have become increasingly popular as a preferred light valve for projection display applications. Typically, multiple micro-displays are used in a projection system, one for each of the primary colors of red, green, and blue. Other uses of micro-displays include direct viewers for personal computing devices such as cellular telephones and personal digital assistants (PDAs).

When manufacturing a projection television system, typically three micro-displays are arranged in three-dimensional space to be optically coupled to an optical system, which will combine images from each of the micro-displays and project a full color image onto a screen. Because of this three-dimensional configuration, flexible connectors (or simply flexes) are typically used to connect display driver circuit boards to the micro-displays.

Often these flexible connectors are installed in a mis-aligned manner to the driver board or micro-display socket such that one or more of the signals from the driver board will not be properly received by the micro-display. Also, the flexible connectors may be knocked loose during shipment or other handling. If one of the connectors is mis-aligned or loose, then the micro-display may be damaged by operation before the fault is detected and repaired.

In light of the foregoing, there is a need for an improved system and method for checking the connection quality between separate circuits such as, for example, a micro-display and driver circuit board in a display system.

### BRIEF DESCRIPTION OF THE DRAWINGS

For a more complete understanding of the present invention, reference is now made to the following figures, wherein like reference numbers refer to similar items throughout the figures:

FIG. 1 is a functional block diagram of a display system including a display; and

FIG. 2 is a functional block diagram of a driver circuit coupled to a display circuit, which includes the display of FIG. 1, in accordance with the present invention.

### DETAILED DESCRIPTION OF THE DRAWINGS

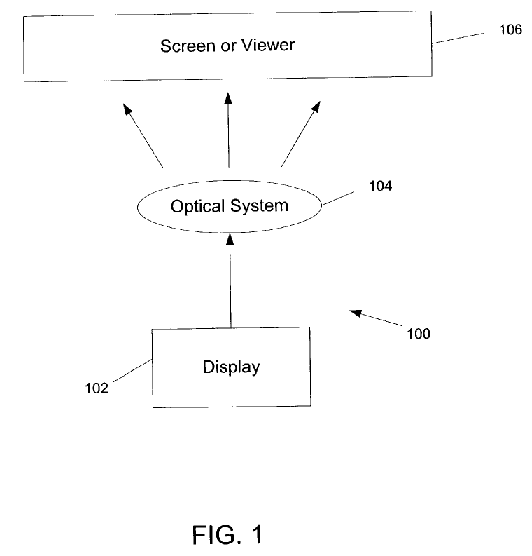

FIG. 1 is a functional block diagram of a display system 100 including a display 102 optically coupled to an optical system 104. Display 102 is, for example, an LCD micro-display used as a source of images to be displayed on a screen or viewer 106 through optical system 104. In other embodiments, more than one micro-display may be used such as, for example, one for each of the primary colors of red, green, and blue.

Display system 100 is, for example, a projection television system using a reflective micro-display. Display system 100 may also include other systems such as a high-resolution projector used for presentations or medical x-ray examination. In other embodiments, display system 100 need not include screen 106 so that a user either directly views images on display 102 or views display 102 with the assistance of some form of optical system 104, such as, for example, a lens that enlarges the images produced or generated by display 102.

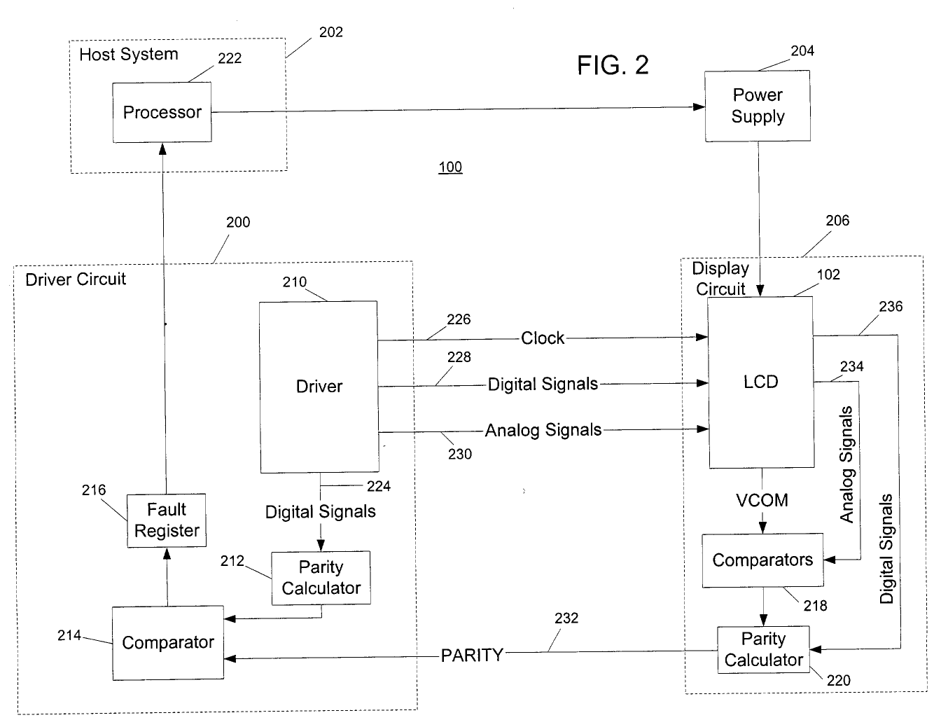

FIG. 2 is a functional block diagram including display 102 along with certain other components of display system 100, such as a driver circuit 200, in accordance with the present invention. Driver circuit 200 is coupled to drive a display circuit 206 which includes display 102 and some additional components for checking parity according to the present invention.

Driver circuit 200 is also coupled to a host system 202, which may be, for example, the controlling electronics for a projection television system. Host system 202 is coupled to control a power supply 204 used to provide power to generate the images on display 102. If a fault is detected during a parity check as described below, then power to display 102 can be shut down by host system 202.

Driver circuit 200 comprises driver electronics or driver 210 for transmitting a clock signal 226, digital signals 228, and analog signals 230 to display 102. Driver 210 is coupled to internally provide digital signals 224, which are the same signals as digital signals 228, to a parity calculator 212 for use as inputs in a parity calculation prior to transmission to display 102. Parity calculator 212 is, for example, a logic gate using an exclusive OR function based on the inputs from digital signals 224.

A first parity output by parity calculator 212 is provided as a first input to a comparator 214. According to the present invention, the first parity is internally calculated in driver circuit 200 using some (or in certain cases, most or all) of the same digital signals to be sent to display circuit 206. A second parity will be calculated by display circuit 206 as described below and then returned to comparator 214 as a second input for comparison to the first parity.

A fault register 216 is coupled to store the result of the comparison from comparator 214. A processor 222 in host system 202 is coupled to register 216 and periodically, for example on every system clock cycle, checks the status of register 216. If the first parity and second parity compared by comparator 214 are different, then a value is stored in register 216 to indicate a fault condition exists. If the fault condition is detected by processor 222 when polling register 216, then processor 222 can initiate other actions. For example, processor 222 can control power supply 204 to shut down power to display 102 to avoid damage or further damage to display 102. Processor 222 reads fault register 216, for example, once each clock cycle and clears register 216 after each read.

In display circuit 206, display 102 receives clock signal 226, digital signals 228, and analog signals 230. Digital signals 228 are, for example, video control signals, and analog signals 230 are, for example, video data being transmitted in, for example, 4, 8, 12, or 24 analog channels. Digital signals 228 control the manner in which analog signals 230 are used by display 102 to generate images for viewing by a user directly or on screen 106. Analog signals 230 corresponding to each of the images to be displayed are typically sent to display 102 at a rate of at least 30 Hz and more typically about 60-120 Hz, and display 102 generates images at a corresponding rate.

Analog signals 234 are internal signals in display circuit 206 and correspond one-to-one to analog signals 230 in the form as received by display circuit 206. Similarly, digital signals 236 are internal signals in display circuit 206 and correspond one-to-one to digital signals 228 in the form as received by display circuit 206. Under normal operation, signals 234 and 230 and signals 236 and 228 should be identical, or substantially identical after parasitic effects are taken into account. However, one or more corresponding pairs of these transmitted and received signals will differ if there has been a mechanical or electrical failure in the mechanical/electrical connection between driver circuit 200 and display circuit 206, which may be, for example, a flexible connector.

Display circuit 206 comprises a plurality of comparators 218, which each accept a signal VCOM from display 102 as a first input and one of the analog signals 234 as a second input. Signal VCOM is a common voltage associated with the operation of display 102. For example, VCOM is the common driving voltage applied to one side or terminal of the LCD pixel array of display 102 and may have a value, for example, between about 3 and 10 volts.

Each of the comparators 218 compares one of the analog signals 234 to VCOM and provides the results as a set of inputs to a parity calculator 220. It should be noted that during normal operation of LCD display 102 when, for example, using frame inversion, all of analog signals 234 will be either above VCOM or below VCOM depending on the particular frame. Thus, normally the results from the set of analog comparisons done by comparators 218 will all be of the same value (either all “one's” or all “zero's”). Each set of analog comparisons is generated typically at a rate of at least 30 sets per second and corresponds to the image generation frequency of display 102.

Parity calculator 220 is, for example, a logic gate implementing an exclusive-OR function having the set of analog comparisons from comparators 218 as inputs along with digital signals 236 as additional inputs. The second parity result 232 from parity calculator 220 is provided as an input to comparator 214 for comparison to the first parity from parity calculator 212 as discussed above.

Discussing driver circuit 200 again, it should be noted that in this embodiment parity calculator 212 does not use analog signals 230 as inputs. This is related to the operation of the exclusive-OR function. More specifically, an exclusive-OR logic gate with an even number of logic “one” inputs produces a logic “zero” output. Similarly, an even number of logic “zero” inputs produces a logic “zero” output. Accordingly, as long as an even number of inputs to an exclusive-OR logic gate each has the same value of logic “one” or “zero”, the output will be a logic “zero”. In this embodiment, analog signals 230 consist of an even number of signals or channels, such as, for example, 4, 8, 12 or 24 channels. For an even number signals each having the same value of a logic “one” or “zero”, if a comparison of analog signals 230 to VCOM or another common voltage were done, the contribution to the parity calculation in parity calculator 212 would be a logic “zero” or of no effect.

As mentioned above, during normal operation when using frame inversion, all of analog signals 234 will be either above VCOM or below VCOM depending on the particular frame, and the results from the set of analog comparisons done by comparators 218 will all be of the same value (either all “one's” or all “zero's”). However, if one of analog signals 234 were to differ in value from all of the other analog signals such as, for example, in the event of an analog signal input failure to display circuit 206, then the contribution of the inputs from comparators 218 to the parity calculation by parity calculator 220 would result in changing the state of parity result 232 to the opposite of the state that would have resulted if there were no analog input failure. This change of state would typically be observed every other frame when using a frame inversion operational mode. Thus, in the event of an analog input failure, this opposite state will not match the parity result from parity calculator 212, indicating the existence of the failure. Examples of possible analog input failures include a broken flex pin or an analog signal being stuck at ground or at a high voltage.

It should be noted that if in other embodiments of the invention there were an odd number of analog signals or channels 230, the quality of the analog channels could be checked by making a minor modification to display circuit 206. For example, in one form of modification an additional input is added to parity calculator 220. The additional input provides a logic “one” during a positive frame, when analog signals 234 are all higher than VCOM during normal operation, and a logic “zero” during a negative frame, when analog signals 234 are all lower than VCOM during normal operation.

Clock 226 synchronizes the transmission of digital signals 228 and analog signals 230 to display 102. The first parity and second parity discussed above are each typically calculated once in the same cycle of clock 226. For example, parity calculator 212 may calculate the first parity at each rising edge of clock 226. Comparator 214 typically compares the first parity and the second parity in the next subsequent clock cycle. In other embodiments, the first and second parity and result from comparator 214 may be calculated in different clock cycles than discussed here.

Driver circuit 200 typically contains a plurality of operational amplifiers (not shown) to generate analog signals 230. An advantage of the present invention is that a failure of one of these amplifiers may be detected by the second parity calculation in parity calculator 220 and subsequent comparison in comparator 214.

Thus, the present invention permits the detection of a problem with digital signals 228 or with analog signals 230, such as a poor mechanical connection or a failure of one of the operational amplifiers. It should be noted, however, that if there is more than one error in the digital signals 228 or analog signals 230, the errors will only be detected if the number of errors is odd.

By the foregoing description, a novel method and system for the checking of signal transmission and mechanical connector integrity between circuits in a display system have been described. The present invention has the advantages of checking the connection quality between separate circuits such as, for example, a micro-display and a driver circuit board, and of detecting failures in digital components or analog amplifiers on the driver circuit board.

Although specific embodiments have been described above, it will be appreciated that numerous modifications and substitutions of the invention may be made. For example, in addition to projection television systems, the present invention may also be used in office projectors, monitors for computer systems, and high-resolution x-ray projector and display systems. Accordingly, the invention has been described by way of illustration rather than limitation.

What is claimed is:

1. A driver circuit operable to provide digital signals to a display and to provide analog signals corresponding to images for viewing by a user to the display, the driver circuit comprising:
a logic circuit to calculate a first parity using the digital signals as inputs; and
a comparator to compare the first parity to a second parity received from the display.

2. The driver circuit of claim 1 wherein only the digital signals are used as inputs for the calculating of the first parity by the logic circuit.

3. The driver circuit of claim 1 wherein the second parity is calculated using the digital signals and the results from comparisons of the analog signals to a common voltage as inputs.

4. The driver circuit of claim 3 wherein the second parity is calculated using an exclusive-OR function.

5. The driver circuit of claim 1 wherein the logic circuit calculates the first parity using an exclusive-OR function.

6. The driver circuit of claim 1 wherein the display is a liquid crystal display.

7. The driver circuit of claim 6 wherein the display is operable to be a portion of a projection television system.

8. The driver circuit of claim 1 wherein the analog signals consist of an even number of signals.

9. The driver circuit of claim 1 wherein the driver circuit is operable to provide a clock signal to the display to synchronize the receipt of the digital signals and the analog signals by the display.

10. The driver circuit of claim 9 wherein:
the first parity is calculated in a first cycle of the clock signal;
the second parity is calculated in the first cycle; and
the comparator compares the first parity to the second parity in a second cycle of the clock signal after the first cycle.

11. The driver circuit of claim 10 wherein the second cycle is the next cycle immediately after the first cycle.

12. The driver circuit of claim 1 wherein the comparator is coupled to a register operable to store a value indicative of a fault condition.

13. The driver circuit of claim 12 wherein:
the register is operable to be coupled to a processor; and
responsive to the register storing the value indicative of the fault condition, the processor is operable to reduce power to the display.

14. The driver circuit of claim 1 wherein:
the first parity is calculated using the digital signals prior to output to the display from the driver circuit; and the second parity is calculated using the digital signals after receipt of the digital signals by the display.

15. A display circuit for creating images corresponding to analog signals received from a driver circuit, wherein the display circuit is operable to receive digital signals from the driver circuit and the driver circuit is operable to calculate a first parity using the digital signals, the display circuit comprising:
a display to generate the images;
a plurality of comparators to compare the voltage of each of the analog signals to a common voltage to provide a plurality of analog comparison signals; and
a logic circuit to calculate a second parity using the digital signals and the plurality of analog comparison signals as inputs and to provide the second parity to the driver circuit.

16. The display circuit of claim 15 wherein the display generates the images at a rate greater than about 30 images per second.

17. The display circuit of claim 16 wherein the images correspond to frames of video data.

18. The display circuit of claim 15 wherein the second parity is calculated using an exclusive-OR function.

19. The display circuit of claim 18 wherein the display is a liquid crystal display.

20. A display circuit for generating a plurality of images corresponding to analog signals received by the display circuit, wherein the display circuit is also operable to receive digital signals, the display circuit comprising:
(a) a liquid crystal display operable to generate the plurality of images;
(b) a plurality of comparators to compare the voltage of each of the analog signals to a common voltage to provide a plurality of sets of analog comparison signals, wherein:
(i) each set of the plurality of sets of analog comparison signals corresponds to one image of the plurality of images;
(ii) each of the analog comparison signals corresponds to one of the analog signals; and
(iii) each of the plurality of sets of analog comparison signals is provided by the plurality of comparators at a rate of at least 30 sets per second; and
(c) a logic circuit to calculate a parity for each of the plurality of images using the digital signals and the corresponding set of analog comparison signals as inputs and to provide the parity as an output signal.

21. The display circuit of claim 20 wherein:
the liquid crystal display comprises a pixel array; and
the common voltage is a voltage applied to a common terminal of the full pixel array.

22. The display circuit of claim 21 wherein the common voltage is between about 3 and 10 V.

23. The display circuit of claim 20 wherein the analog signals are either all above the common voltage or all below the common voltage during normal operation of the display circuit.

24. The display circuit of claim 23 wherein the number of analog signals is even.

25. The display circuit of claim 20 wherein the digital signals correspond to the analog signals and control the generating of the images by the display.

26. A display system comprising:
(a) a driver circuit operable to output digital signals and to output analog signals corresponding to a plurality of images for viewing by a user, the driver circuit comprising a first logic circuit to calculate a first parity using the digital signals, prior to output from the driver circuit, as inputs; and
(b) a display circuit coupled to receive the digital signals and the analog signals from the driver circuit, the display circuit comprising:
(i) a display to generate the plurality of images; and
(ii) a second logic circuit to calculate a second parity using at least the digital signals as inputs, wherein the driver circuit is coupled to receive the second parity for comparison with the first parity.

27. The display system of claim 26 wherein the driver circuit further comprises a comparator coupled to receive the first parity from the first logic circuit and coupled to receive the second parity from the display circuit.

28. The display system of claim 27 wherein the comparator is operable to compare the first parity to the second parity and, responsive to the first parity being different from the second parity, provide an output indicative of a fault condition.

29. The display system of claim 28 wherein the comparator is coupled to a register operable to store the output indicative of the fault condition.

30. The display system of claim 29 further comprising:
a processor coupled to the register; and
a power supply coupled to provide power to the display, wherein the processor is coupled to control the power supply and, responsive to the register storing the output indicative of the fault condition, the processor is operable to reduce power provided from the power supply to the display.

31. The display system of claim 26 wherein the display circuit further comprises a plurality of comparators to compare the voltage of each of the analog signals to a common voltage to provide a plurality of sets of analog comparison signals, wherein each set of the plurality of sets of analog comparison signals corresponds to one image of the plurality of images, and each of the analog comparison signals corresponds to one of the analog signals.

32. The display system of claim 31 wherein:
the display is a liquid crystal display comprising a pixel array; and
the common voltage is a voltage applied to a common terminal of the full pixel array.

33. The display system of claim 31 wherein the analog signals are either all above the common voltage or all below the common voltage during normal operation of the display system.

34. The display system of claim 31 wherein the second parity is calculated for each of the plurality of images.

35. The display system of claim 34 wherein the second logic circuit uses, for each of the plurality of images, the corresponding set of analog comparison signals as additional inputs for calculating the second parity.

36. The display system of claim 35 wherein the display is a liquid crystal display.

37. The display system of claim 36 wherein the analog signals consist of an even number of analog signals.

38. The display system of claim 31 wherein each of the plurality of sets of analog comparison signals is provided by the plurality of comparators at a rate of at least 30 sets per second.

39. The display system of claim 38 wherein the display generates images at a rate greater than about 30 images per second.

40. The display system of claim 26 wherein the images correspond to frames of video data.

41. The display system of claim 26 wherein the first parity and the second parity are each calculated using an exclusive-OR function.

42. The display system of claim 26 wherein the display system is selected from the group consisting of: a projection television system, a computer monitor, a cellular telephone, and a portable electronic device.

43. A projection television system comprising the display system of claim 26.

44. A cellular telephone comprising the display system of claim 26.

45. A method for monitoring the operation of a display system, the method comprising:
calculating a first parity using a plurality of digital signals;
transmitting the plurality of digital signals to control the generation of a plurality of images;
transmitting a plurality of analog signals to provide a source for the plurality of images;
calculating a second parity using the plurality of digital signals and the plurality of analog signals; and
comparing the first parity to the second parity to detect a fault condition.

46. The method of claim 45 further comprising, responsive to the detection of the fault condition, terminating the generation of the plurality of images.

47. The method of claim 45 wherein calculating the second parity using the plurality of digital signals and the plurality of analog signals comprises comparing each of the plurality of analog signals to a common voltage to provide a plurality of analog comparison signals for use as inputs in calculating the second parity.

48. The method of claim 47 wherein the common voltage corresponds to a common terminal of a liquid crystal display.

49. The method of claim 47 wherein the first parity and the second parity are calculated using an exclusive-OR function.

50. The method of claim 45 further comprising providing a clock signal to synchronize the transmitting of the plurality of digital signals and the plurality of analog signals.

51. The method of claim 50 wherein:
the first parity is calculated in a first cycle of the clock signal;
the second parity is calculated in the first cycle; and
the first parity is compared to the second parity in a second cycle of the clock signal after the first cycle.

52. The driver circuit of claim 51 wherein the second cycle is the next cycle immediately after the first cycle.

53. A method for operating a projection television system comprising the method of claim 45.
